(19) United States
(12) Patent Application Publication
(10) Pub. No.: US 2013/0033187 A1
(43) Pub. Date: Feb. 7, 2013

(54) Wireless monitoring and control device for indoor and outdoor lighting

(71) Applicants: Zane Brown, Sylvester, GA (US); Joe Dylinski, Sylvester, GA (US); James Hoye Hillhouse, Memphis, TN (US); James D. McIngvale, JR., Hernando, MS (US); Bryan Pike, Sylvester, GA (US)

(72) Inventors: Zane Brown, Sylvester, GA (US); Joe Dylinski, Sylvester, GA (US); James Hoye Hillhouse, Memphis, TN (US); James D. McIngvale, JR., Hernando, MS (US); Bryan Pike, Sylvester, GA (US)

(73) Assignee: Eagle Wireless MAC, LLC

(21) Appl. No.: 13/068,510

(22) Filed: Aug. 1, 2011

(51) Int. Cl. H05B 37/02

(52) U.S. Cl. 315/201

(57) ABSTRACT

The invention provides a wireless means of power monitoring and control of lighting fixtures. The device consists of five sections; line voltage AC to DC convertor and DC power circuit, voltage sensing circuit, current sensing circuit, relay circuit, and wireless microcontroller (“WUC”). Power input to the device is made via a multi-pronged connector (“MPC”). The AC to DC convertor reduces voltage to an acceptable level for the DC voltage circuit to power the circuitry on the printed circuit boards. A logic-controlled relay circuit provides on/off control of the light fixture outputting to the “Load” terminal of the MPC. Line voltage from the MPC enter current and voltage sensing circuits, continues through signal shaping circuits, and is provided to the WUC for processing. The two input signals are scaled and computed to provide power consumption values which are then transmitted wirelessly to a building automation control network.

### UTILITY PATENT

Wireless remote monitoring and control system for energy consuming devices.

### APPLICANT

Eagle Wireless MAC, LLC, as rights are assigned by the named inventors, Zane Brown, Joe Dylinski, James H. Hillhouse, J D McIngvale and Bryan Pike, as members of AIC Partners Group, LLC and J & J Partners, LLC, who in turn are Members of Eagle Wireless MAC, LLC.

### OVERVIEW

The embodiment of this system of point monitoring and control (referred to as a node or BULIT®) consists of a unique design of electronic multi-pole outputs (with capabilities for up to eight (8) analog and digital inputs and outputs. Those outputs communicate by unregulated radio frequencies (typically, 2.4 gigahertz) to a receiving device (Jace) of an existing design utilizing in one embodiment of the concept, Sedona® technology.

Typical applications are foreseen to be, but are not limited to:
a. Outdoor lighting systems
b. Indoor lighting systems
c. Seating and cooling systems
d. Security devices such as signal lights, cameras,
e. Power meters, water meters, gas meters, etc.

The Jace then takes signals to or from the node/BULIT®, or sends signals to the node/BULIT® utilizing in one embodiment a Niagara® framework. The Jace may transfer the signal to the Ethernet for custom software established to time the work of the device to the specific functional needs of the system being controlled.

The node/BULIT® (one embodiment shown in the electrical schematic attached)) interfaces with the equipment being controlled through electrical interface to the main equipment power (Line-Neutral) and the switching of that power through a load lead to control. The actual switching may be done with one integral relay or use the integral relay to control a high current-load switching relay.

Various electrical embodiments include:
a. Single point switching (Feature)
b. Multipoint switching
c. Multiple analog and digital outputs (Feature)
d. Powering of the device with solar-charged backup batteries
e. Monitoring the “one state” of the controlled device with a direct indicator of the operation (such a the current flow thru the switched or load leg (Feature)
f. Reading the current drawn by the device or devices being controlled
g. Reading the input power by the device or devices being controlled
h. Solar power monitoring and control.

Power connection to the node/BULIT® is typically embodied by:
a. Hard wire connections using various electrical terminations such as wire nuts
b. Electromechanical interfaces such as NEMA twist and lock interfaces.

Mechanical embodiments include:
a. Externally mounted BULIT® of the configuration described on patent application Ser. No. 29/370,695, interfacing to the device to be monitored and controlled through a standard NEMA twistlock interface.
b. Weatherproof NEMA enclosure—with hardwire provisions.

### BRIEF DESCRIPTION OF DRAWINGS

FIG. 1: Circuit board top layer artwork and silkscreen

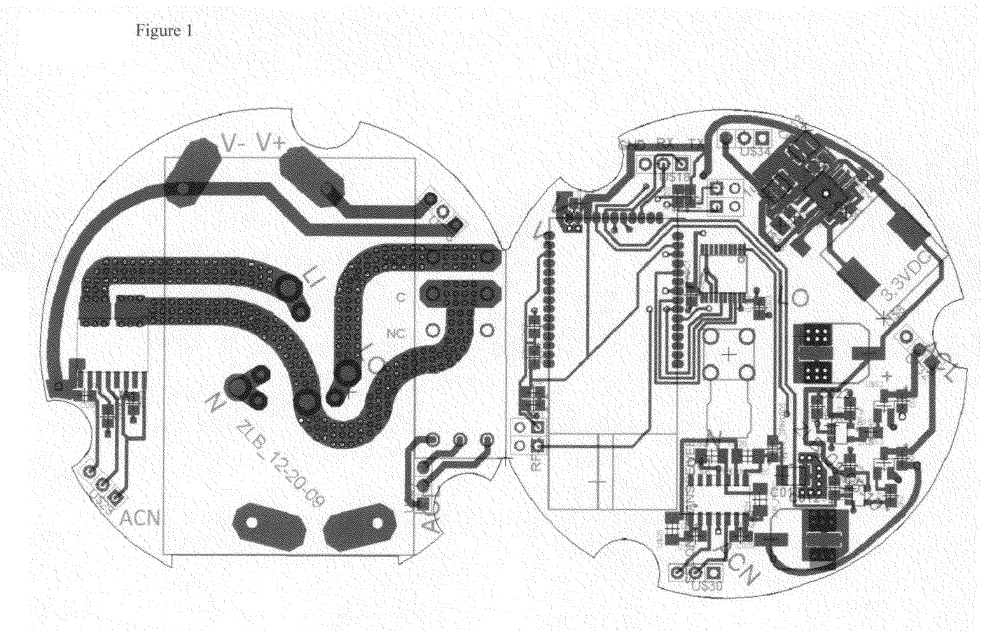

FIG. 2: Circuit board bottom layer artwork and silkscreen

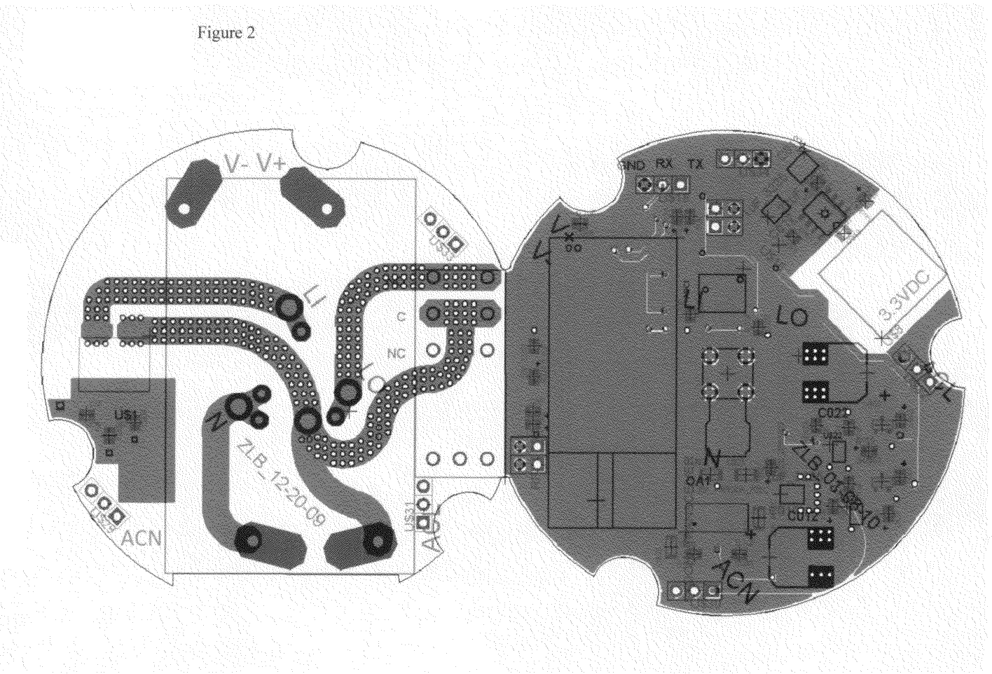

FIG. 3: Circuit board top and bottom layers of artwork and silkscreen

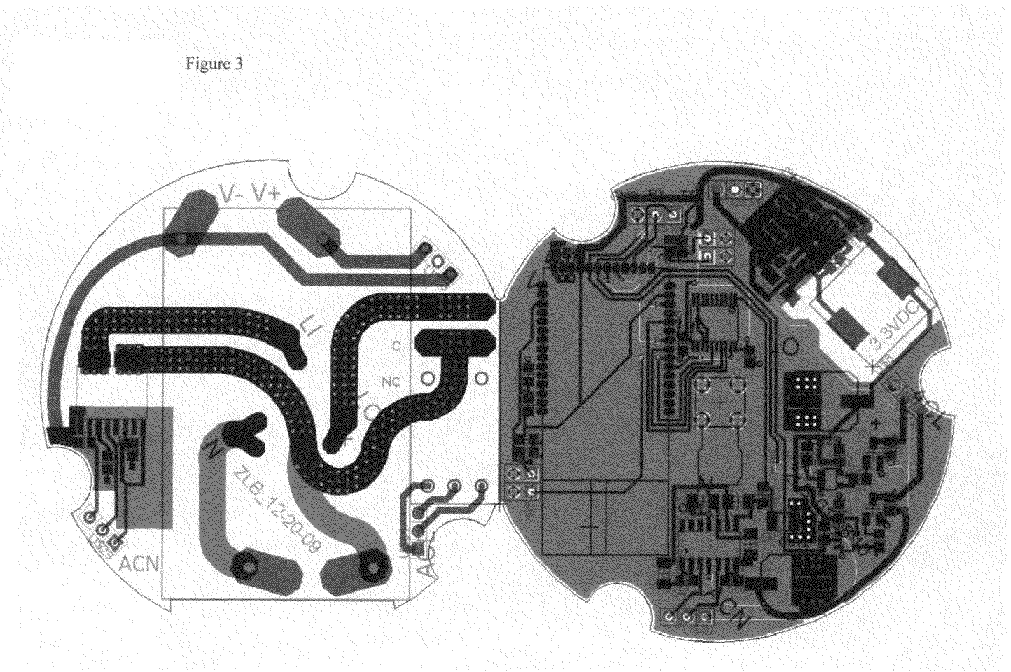

FIG. 4A: Relay section schematic

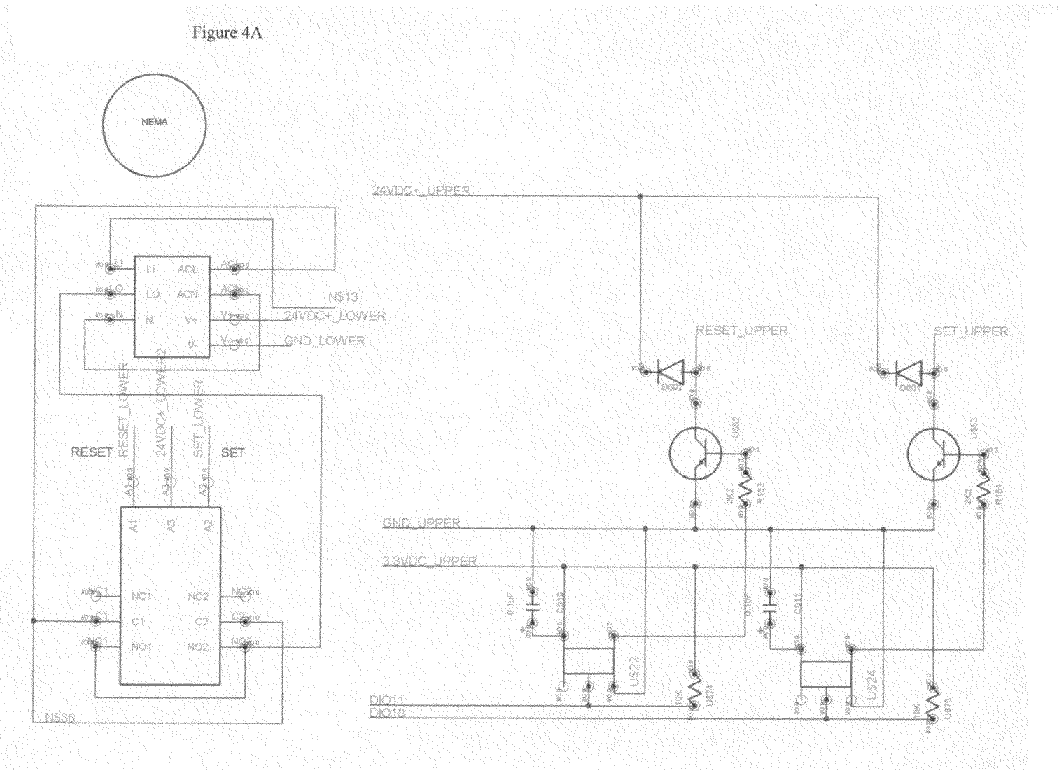

FIG. 4B: Fallback mode connection schematic

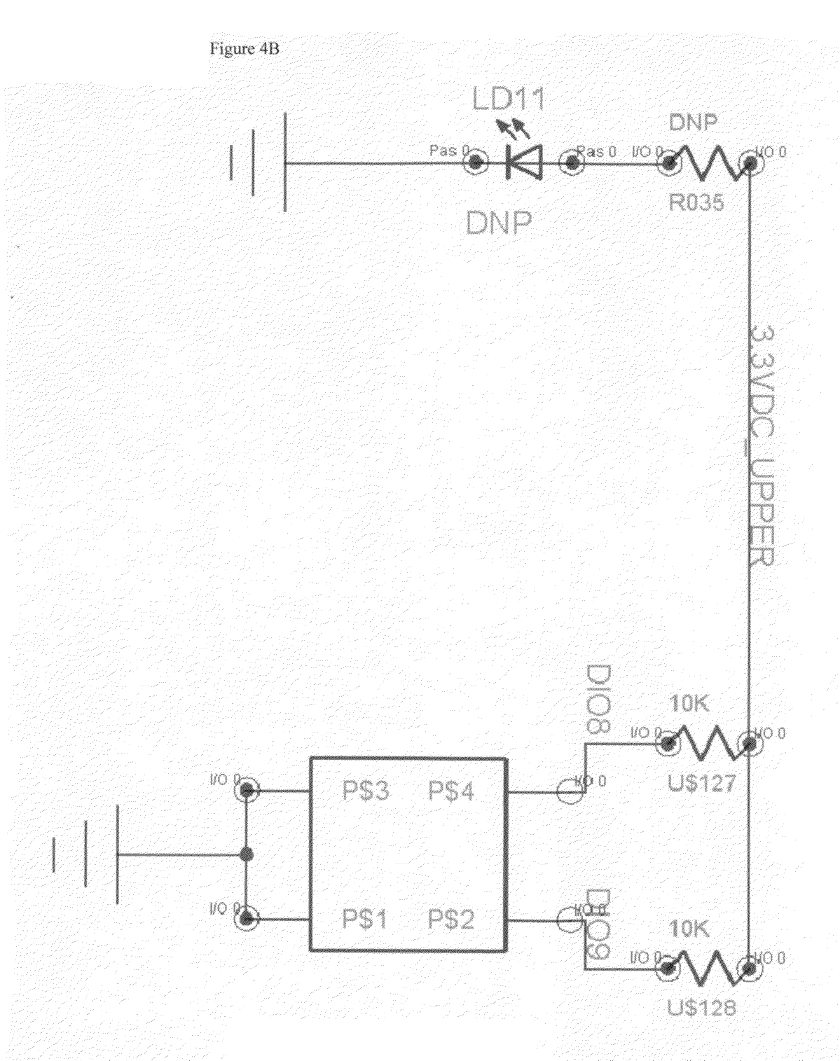

FIG. 4C: Antenna connection schematic

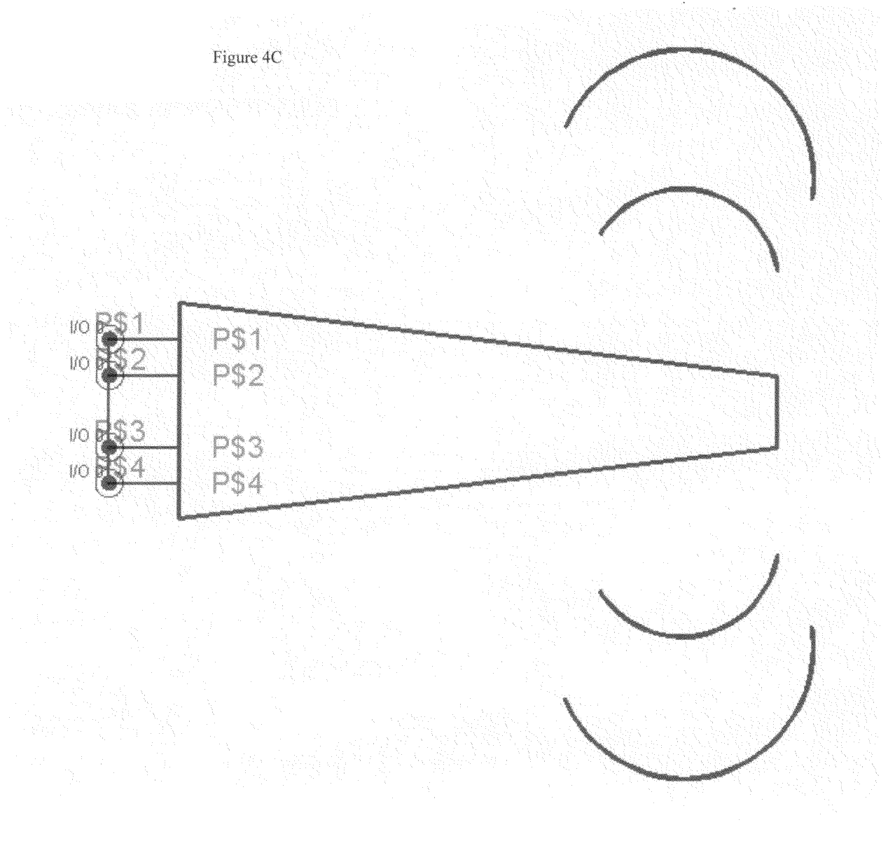

FIG. 4D: Voltage and current monitoring schematic

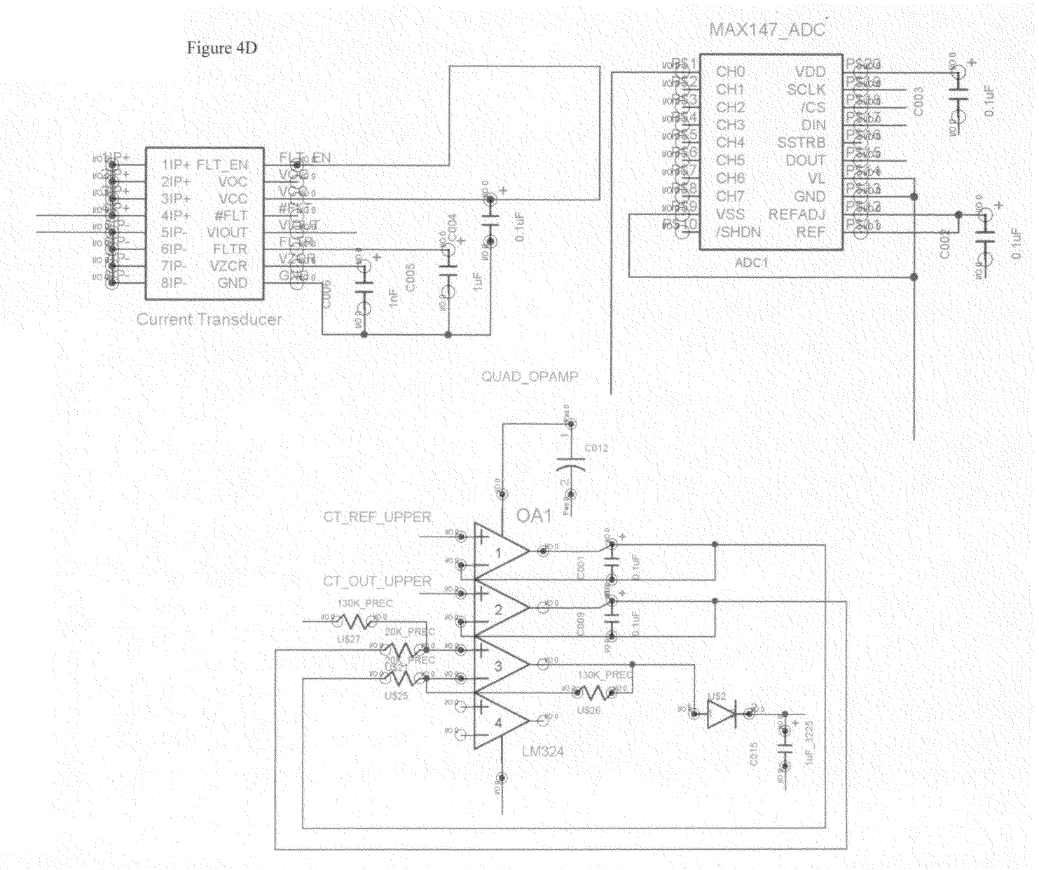

FIG. 4E: High and low voltage power schematic

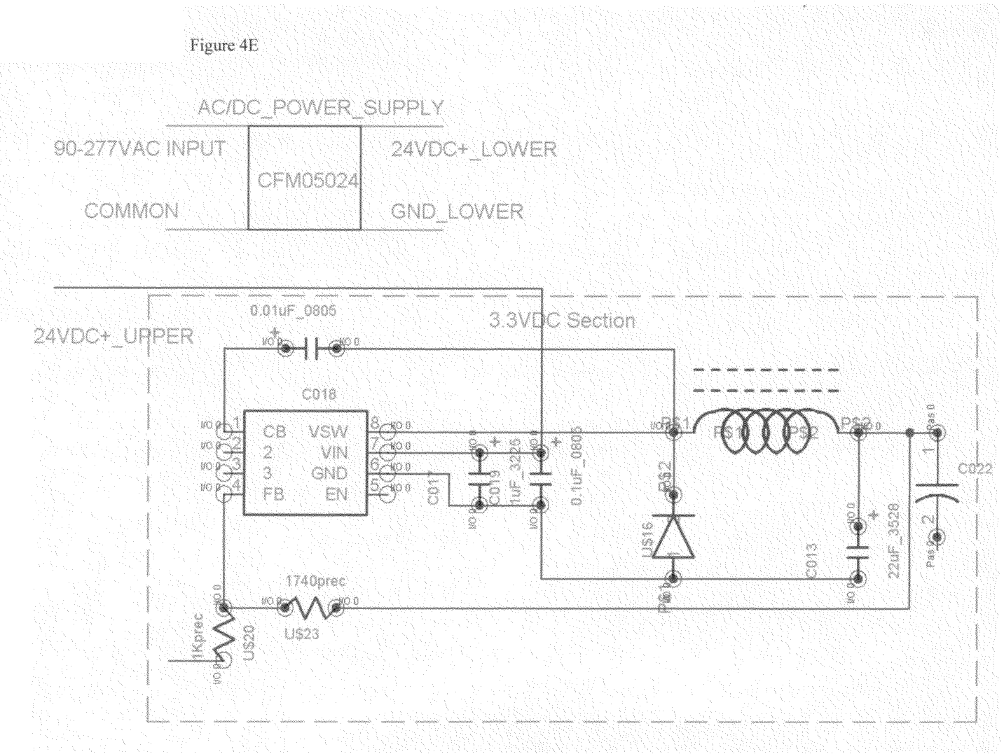

FIG. 4F: Wireless microcontroller schematic

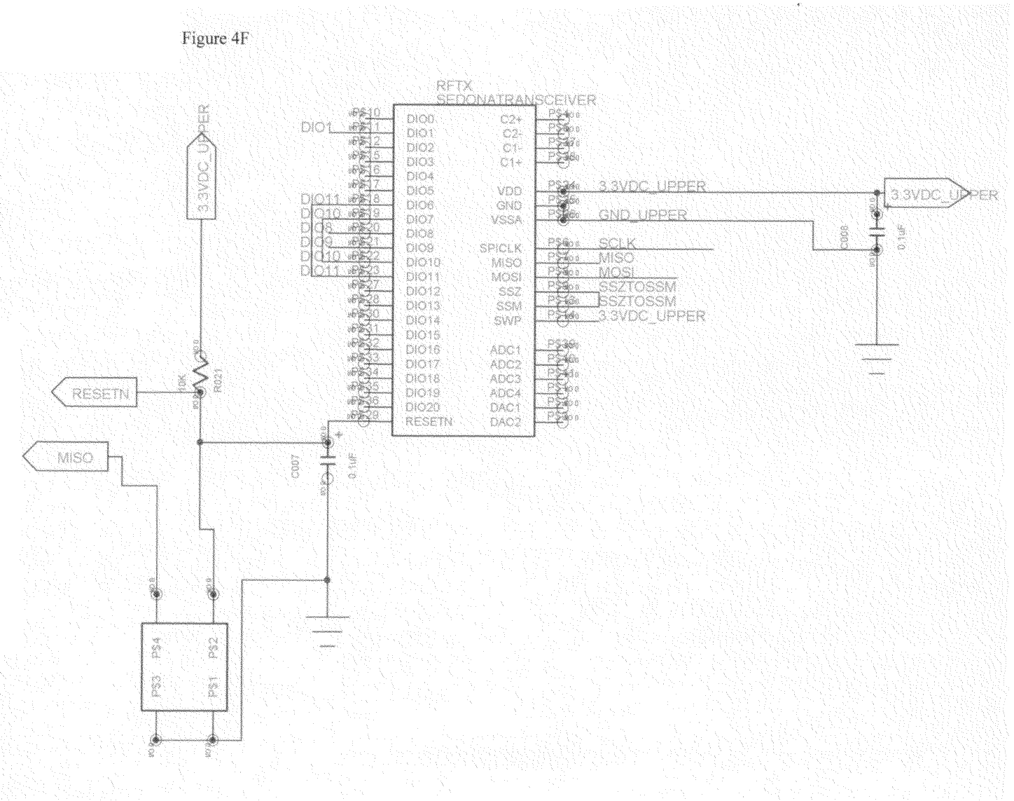

FIG. 4G: Connectors schematic

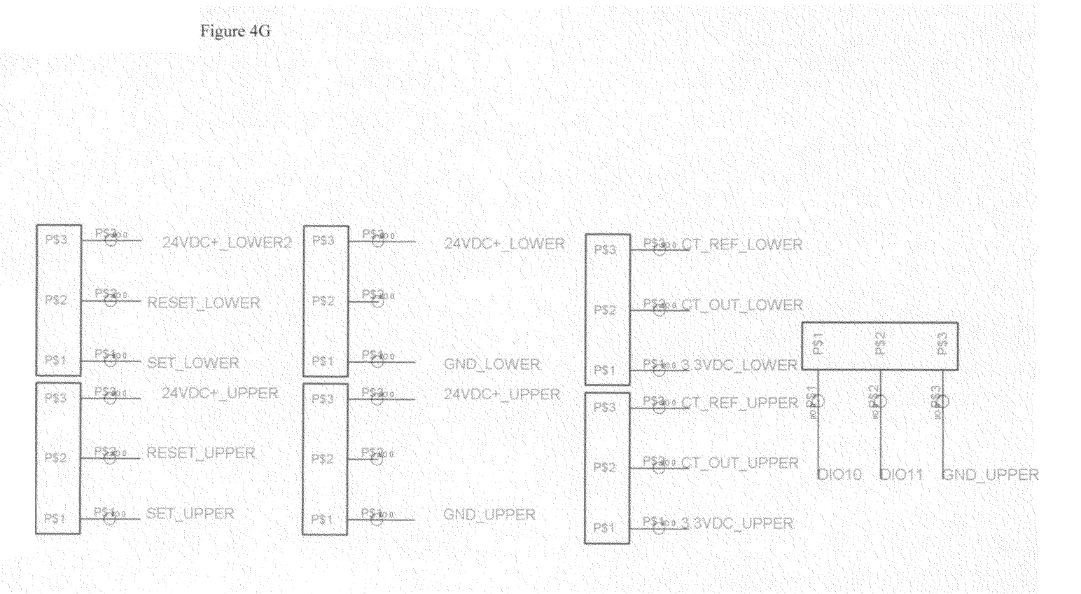

### REFERENCE PATENTS

| | | |
|---|---|---|
| 6,028,396 | Feb. 22, 2000 | Morrissey, Jr., et al. |
| 6,452,339 | Sep. 17, 2002 | Morrissey, et al. |
| 7,256,556 | Aug. 14, 2007 | Lane, et al. |
| 7,284,878 | Oct. 23, 2007 | Dorogi, et al. |
| 7,333,903 | Feb. 19, 2008 | Walters, et al. |
| 7,529,594 | May 5, 2009 | Walters, et al. |
| 7,546,167 | Jun. 9, 2009 | Walters, et al. |
| 7,546,168 | Jun. 9, 2009 | Walters, et al. |
| 7,603,184 | Oct. 13, 2009 | Walters, et al. |
| 7,761,260 | Jul. 20, 2010 | Walters, et al. |
| 7,911,359 | Mar. 22, 2011 | Walters, et al. |

1. A device for the wireless monitoring and control of lighting fixtures consisting of a combined set of circuits; AC to DC convertor and DC power circuit, voltage sensing circuit, current sensing circuit, relay circuit, and wireless microcontroller(“WUC”).

2. Power enters the device base assembly via a general multi-pronged connector (“MPC”). Line voltage connections are made, in series with a current sensing integrated circuit (“IC”), to the AC to DC converter from claim 1. Voltage level and type are converted and stepped-down from commercially available 110 VAC-277 VAC type to 24 volts DC. Said 24 volts DC enters the DC power circuit from claim 1 and is stepped down to 3.3 volts DC (VCC).

3. Continued from the DC power circuit of claim 2, the 3.3 volts DC power circuit output is shared to all subsequent VCC connections on all subsequent circuit sections.

4. Line voltage connections are made, bypassing the current sensing IC, to the voltage sensing circuit from claim 1. Line voltage is rectified via a high voltage diode. Voltage leaves the rectifier diode and enters a voltage-dividing resistor network where, upon exiting, it continues to an operational amplifier (“OA”). Voltage output from the OA enters a schottky diode. Upon exiting the schottky diode, voltage enters a storage cap while paralleled to an input channel (IN2) of an analog-to-digital converter (“ADC”). Upon leaving the ADC, a proportional digital value equal to (VCC/IN2)*4095 is presented to the WUC.

5. Current sensing IC from claim 2 outputs a, waveform synonymous, DC-offset, voltage (“Vout”) which is centered around ½VCC proportional to the total AC current consumption of said device and subsequent connected lighting fixture. The same IC outputs a voltage reference that is ½VCC (“Vref”). Both outputs, Vout and Vref, are connected to an OA. The OA applies gain and removes the ½VCC offset from the Vout signal. The output from the OA continues to a schottky diode. Upon exiting the schottky diode, the signal is connected to a storage capacitor while paralleled to an input channel (IN1) of an ADC. Upon leaving the ADC, a proportional digital value equal to (VCC/IN1)*4095 is presented to the WUC.

6. Line voltage connections are made, in series with a current sensing IC, to the relay circuit of claim 1. Relay circuit is comprised of various resistors, capacitor, transistors, and a relay. The WUC controls the inputs to the circuit to command the relay to a desired state. The output from the relay is connected to the load terminal of the MPC to provide control of the subsequently connected lighting fixture.

7. The WUC in claim 1 gathers the digital signals from the ADC in claims 4 and 5 and combines those values with various control and mathematical program logic to determine power usage of the device and subsequently connected lighting fixtures. The WUC also contains program logic to control the output state of the relay. The WUC has various input connections for programming the software and hardware logic as well as the wireless communication parameters.
